(19) United States
(12) Patent Application Publication
(10) Pub. No.: US 2026/0106495 A1
(43) Pub. Date: Apr. 16, 2026

(54) WIRELESS CHARGING DEVICE

(71) Applicant: Panasonic Automotive Systems Co., Ltd., Kanagawa (JP)

(72) Inventors: Satoshi TOMITA, Kanagawa Ken (JP); Takuya FUJIWARA, Kanagawa Ken (JP); Ryouhei SUZUKI, Kanagawa Ken (JP); Takeshi KUNII, Tokyo To (JP); Ken HATAKEYAMA, Kanagawa Ken (JP); Mingxue ZHANG, Kanagawa Ken (JP); Shigenori HOSHINA, Kanagawa Ken (JP); Atsutoshi NARAKI, Kanagawa Ken (JP)

(73) Assignee: Panasonic Automotive Systems Co., Ltd., Kanagawa (JP)

(21) Appl. No.: 19/355,580

(22) Filed: Oct. 10, 2025

(30) Foreign Application Priority Data
Oct. 15, 2024 (JP) 2024-180252

(51) Int. Cl. H02J 50/90; H02J 50/00; H02J 50/10

(52) U.S. Cl. CPC H02J 50/90; H02J 50/005; H02J 50/10

(57) ABSTRACT

A wireless charging device according to an embodiment wirelessly charges an information processing device via a charging coil. The information processing device includes a camera module that protrudes from a body of the information processing device. The body of the information processing device includes a charged coil. The wireless charging device includes a mounting part in which the charging coil is provided. The mounting part includes a first surface on which the body of the information processing device is to be mounted. The wireless charging device includes a camera retraction part that retracts the camera module. The camera retraction part includes a second surface that faces the camara part with a gap in a state where the body of the information processing device is mounted at a predetermined position on the first surface.

### CROSS-REFERENCE TO RELATED APPLICATIONS

This application is based upon and claims the benefit of priority from Japanese Patent Application No. 2024-180252, filed on Oct. 15, 2024, the entire contents of which are incorporated herein by reference.

### FIELD

The present disclosure relates generally to a wireless charging device.

### BACKGROUND

Conventional wireless charging uses a mechanism that is based on the principle of electromagnetic induction between coils included in a charging device and a smartphone (See, for example, Patent Literature JP 2013-240243 A). In wireless charging of a moving-coil type or the like, the charging performance is affected by the shape of each of coils, a degree of matching between the centers of the coils, and a distance between the coils.

Incidentally, for the purpose of improvement of the camera performance in recent smartphones, there is a tendency for their camera modules to increase in an amount of protrusion from the back surfaces of the smartphones.

With such a tendency, there may be a problem that the camera modules of the smartphones mounted on the wireless charging devices are caught on charging surfaces, and thereby the back surfaces of the smartphones are raised. As a result, a distance between the charging/charged coils increases, causing deterioration in charging performance.

### SUMMARY

A wireless charging device according to an embodiment wirelessly charges an information processing device via a charging coil. The information processing device includes a camera module protruding from a body of the information processing device. The body of the information processing device includes a charged coil. The wireless charging device includes a mounting part in which the charging coil is provided. The mounting part includes a first surface on which the body of the information processing device is to be mounted. The wireless charging device includes a camera retraction part that retracts the camera module. The camera retraction part includes a second surface that faces the camara part with a gap in a state where the body of the information processing device is mounted at a predetermined position on the first surface.

### BRIEF DESCRIPTION OF THE DRAWINGS

FIG. 1 is a perspective view (1) illustrating an external appearance of a wireless charging device according to a first embodiment;

FIG. 2 is a perspective view (2) illustrating an external appearance of the wireless charging device according to the first embodiment;

FIG. 3 is a plan view of the wireless charging device according to the first embodiment;

FIG. 4 is a side view of the wireless charging device according to the first embodiment;

FIG. 5 is an explanatory diagram of a use state of the wireless charging device according to the first embodiment;

FIG. 6 is an explanatory view of a mounting state of the wireless charging device installed in a vehicle;

FIG. 7 is a perspective view (1) of an external appearance of a wireless charging device according to a second embodiment illustrating a non-use state;

FIG. 8 is a perspective view (2) of an external appearance of the wireless charging device according to the second embodiment illustrating a non-use state;

FIG. 9 is a plan view of the wireless charging device according to the second embodiment;

FIG. 10 is a cross-sectional view taken along line D-D of FIG. 9;

FIG. 11 is a perspective view (1) of an external appearance of the wireless charging device according to the second embodiment illustrating a use state;

FIG. 12 is a perspective view (2) of an external appearance of the wireless charging device according to the second embodiment illustrating a use state;

FIG. 13 is a cross-sectional view of a use state corresponding to the cross-section taken along line D-D of FIG. 9;

FIG. 14 is a plan view of a charging device body unit 40;

FIG. 15 is a perspective view illustrating an external appearance of the charging device body unit 40;

FIG. 16 is an explanatory diagram of a use state of the wireless charging device according to the second embodiment;

FIG. 17 is an explanatory diagram of the wireless charging device according to the second embodiment illustrating an installed state (non-use state) in a vehicle;

FIG. 18 is an explanatory diagram of the wireless charging device according to the second embodiment illustrating an installed state (use state) in the vehicle;

FIG. 19 is a perspective view of an external appearance of a wireless charging device according to a third embodiment illustrating a non-use state;

FIG. 20 is a plan view of the wireless charging device according to the third embodiment;

FIG. 21 is a cross-sectional view of a non-use state taken along line A-A of FIG. 20;

FIG. 22 is a perspective view of an external appearance of the wireless charging device according to the third embodiment illustrating a use state;

FIG. 23 is a cross-sectional view of a use state taken along line A-A of FIG. 20; and

FIG. 24 is an explanatory diagram of the use state of the wireless charging device according to the third embodiment.

### DETAILED DESCRIPTION

Next, embodiments will be described in detail with reference to the drawings.

### First Embodiment

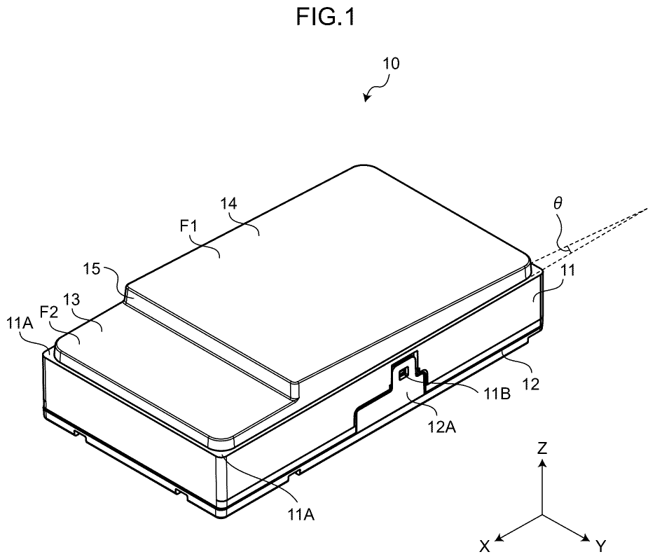

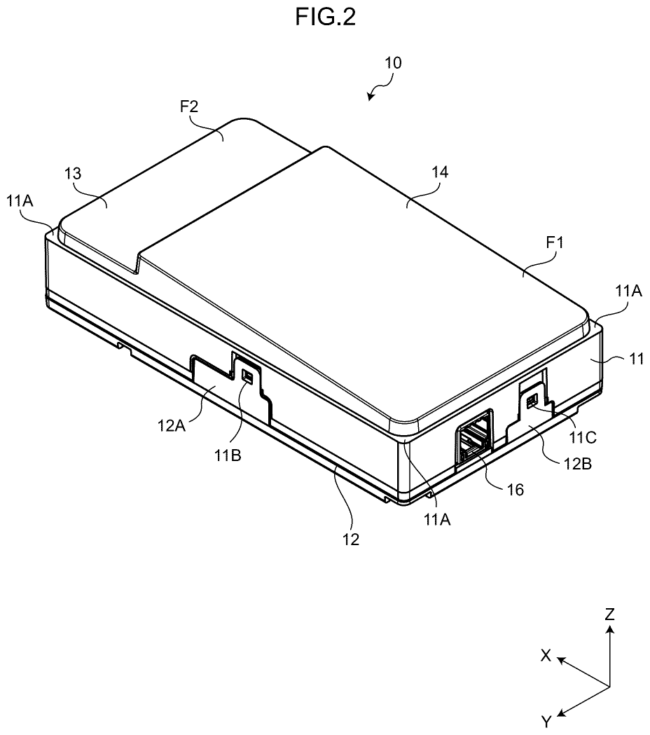

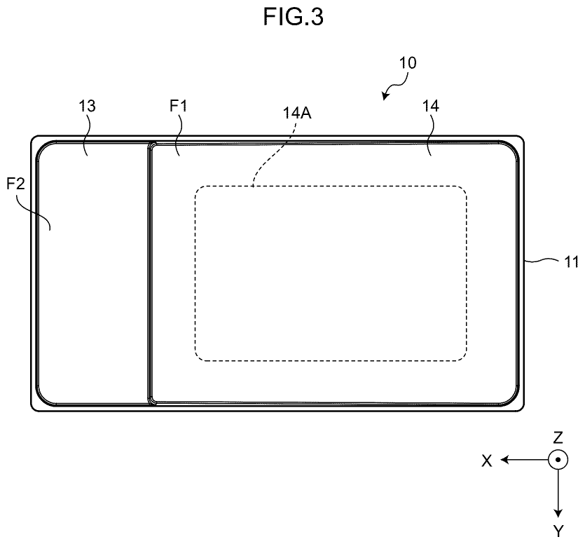

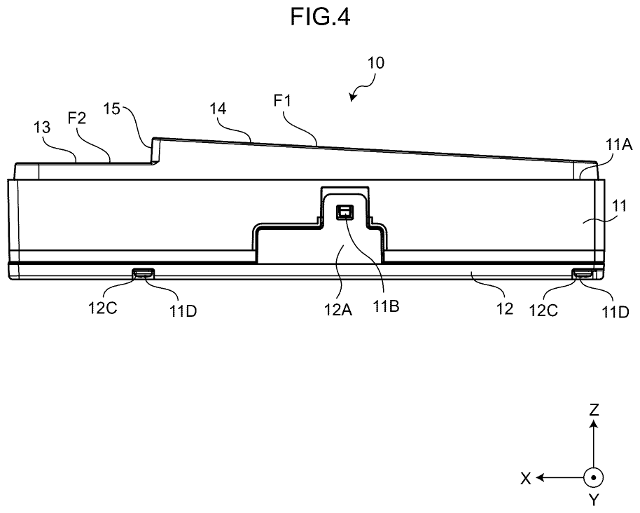

FIG. 1 is a perspective view (1) illustrating an external appearance of a wireless charging device of a first embodiment. FIG. 2 is a perspective view (2) illustrating an external appearance of the wireless charging device according to the first embodiment. FIG. 3 is a plan view of the wireless charging device according to the first embodiment. FIG. 4 is a side view of the wireless charging device according to the first embodiment. The drawings each show an X-axis, a Y-axis, and a Z-axis, in which a direction indicated by a head of each arrow is defined as a positive direction, and a direction indicated by a tail of each arrow is defined as a negative direction (hereinafter, the same shall apply).

A wireless charging device 10 of the first embodiment is used by being installed in, for example, a tray or the like provided in a center console of a vehicle.

The wireless charging device 10 includes an upper case 11, a lower case 12, and a power connector 16. The upper case 11 has a rectangular shape in a plan view (as viewed in the Z-axis positive direction). Additionally, the upper case 11 includes a camera retraction part 13, a main-body mounting part 14, and a stepped part 15.

The camera retraction part 13 is formed on an end side of the upper case 11 in an X-axis direction (positive direction of X-axis). In order to prevent a camera module, which protrudes from a portable information processing device such as a smartphone to be charged, from abutting on the wireless charging device 10 and from being scratched, the camera retraction part 13 is formed by setting the height of the stepped part 15 to be larger than the protruding height of the camera module of the portable information processing device. The camera retraction part 13 has an upper surface that corresponds to a second surface F2.

The main-body mounting part 14 is provided on a rear end side in the X-axis direction (negative direction of X-axis). The main body of the portable information processing device is mounted on the main-body mounting part 14 when the portable information processing device is charged. The main-body mounting part 14 has an upper surface that corresponds to a first surface F1. On an inner surface side of the upper case 11 of the main-body mounting part 14, namely, on a back surface side of the first surface F1, a charging coil 14A (see FIG. 3) including a charging coil is provided in parallel with a flat surface of the main-body mounting part 14. The charging is performed by utilizing electromagnetic coupling.

In this configuration, the main-body mounting part 14 has a mounting surface that is not a horizontal surface but an inclined surface with predetermined angle θ, as illustrated in FIG. 1 This is because, the main body of the portable information processing device is mounted with a side surface of the camera module of the portable information processing device abutting on the stepped part 15, positional deviation of the portable information processing device is prevented, and a change in position with respect to a charged coil provided inside the portable information processing device is suppressed, for more reliable charging.

The stepped part 15 serves to connect the camera retraction part 13 and the main-body mounting part 14. As described above, by causing the side surface of the camera module of the portable information processing device to abut on the stepped part, the positional deviation of the portable information processing device during charging can be suppressed.

FIG. 3 is a plan view of the wireless charging device according to the first embodiment. The charging coil 14A including a charging coil is provided on the back surface side of a main-body mounting surface of the main-body mounting part 14 of the wireless charging device 10.

The lower case 12 stores, in cooperation with the upper case 11, a charging circuit including the charging coil, and the power connector 16. In FIGS. 1 and 2, first engagement pieces 12A are provided on side surfaces of the lower case 12 of the wireless charging device 10 in the Y-axis direction. The first engagement pieces 12A are each engaged with first engagement protrusion 11B provided on each side surface of the upper case 11 in the Y-axis direction.

As illustrated in FIG. 2, a second engagement piece 12B is provided on a side surface of the lower case 12 of the wireless charging device 10 in the X-axis negative direction (lower right side surface in FIG. 2). The second engagement piece 12B is engaged with a second engagement projection 11C provided on a side surface of the upper case 11 in the X-axis negative direction. The upper case 11 and the lower case 12 are thereby integrally formed. Therefore, it is possible to prevent liquid such as water, and dust from entering the interior of the integral case constituted by the upper case 11 and the lower case 12.

Under the control of a control circuit (not illustrated), the charging coil 14A is electrically controlled such that the charged coil of the portable information processing device and the charging coil of the wireless charging device 10 have the positional relationship that enables the charging efficiency to be the highest level.

FIG. 4 is a side view of the wireless charging device according to the first embodiment. Engagement holes 12C are provided in a lower end part of the lower case 12 of the wireless charging device 10. The engagement holes 12C are each engaged with a corresponding engagement protrusion 11D provided in the upper case 11 to integrate the upper case 11 and the lower case 12 more firmly.

As illustrated in FIG. 4, when the second surface F2 serving as the camera retraction part 13 is a horizontal surface, the first surface F1 serving as the main-body mounting part 14 is inclined at the predetermined angle θ so as to have a height that decreases as the first surface F1 separates from the camera retraction part 13 in an extending direction of the body of the information processing device.

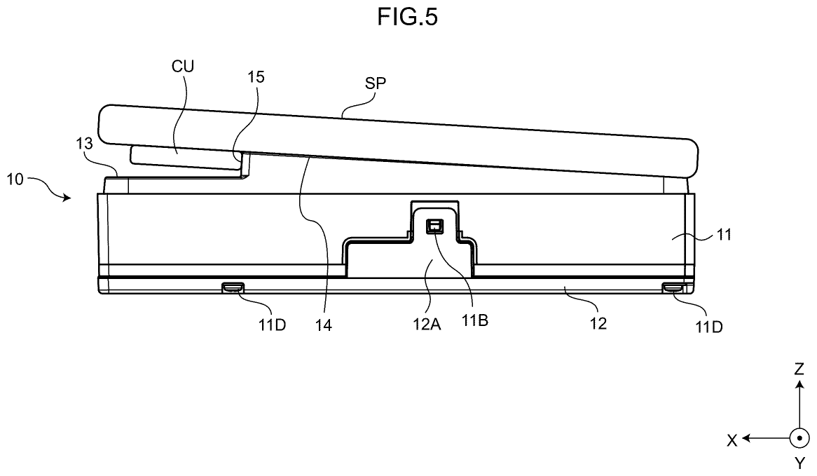

FIG. 5 is an explanatory diagram of a use state of the wireless charging device according to the first embodiment. When a portable information processing device SP is mounted along the main body mounting surface of the main-body mounting part 14 of the wireless charging device 10, it is preferable to mount the portable information processing device SP such that, as illustrated in FIG. 5, a side surface of a camera module CU of the portable information processing device SP abuts on the stepped part 15.

This is because the portable information processing device SP is allowed to be stably held, the positional deviation of the portable information processing device during charging is suppressed, and a decrease in charging efficiency between the charging coil and the non-charging coil is suppressed.

The camera module CU of the portable information processing device SP has a surface in the Z-axis negative direction, which is configured to prevent from abutting on the upper surface of the camera retraction part 13 due to the height of the stepped part 15. Therefore, the charged coil of the portable information processing device SP is allowed to face the charging coil of the wireless charging device 10 more closely.

Moreover, on the surface of the camera module CU in the Z-axis negative direction, there is no possibility that the upper surface of the camera retraction part 13 is, for example, scratched due to the height of the stepped part 15.

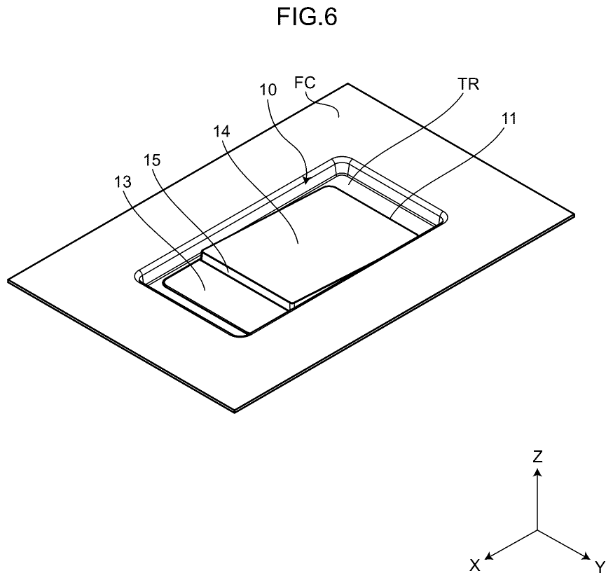

FIG. 6 is an explanatory view of a mounting state of the wireless charging device installed in a vehicle. In one example, the wireless charging device 10 is installed in the vehicle while being mounted to a tray TR provided in a front console FC.

In such a configuration above, an abutment surface 11A of the upper case 11 is arranged to abut on a back surface side of the tray TR, and only the camera retraction part 13, the main-body mounting part 14, and the stepped part 15 of the upper case 11 are protruded from an upper surface side of the tray TR. Therefore, the wireless charging device 10 can be installed in the vehicle without unnecessarily restricting the function of the tray TR provided in the front console FC.

In addition, the front console FC is originally arranged at a position convenient for an occupant (including a driver) of the vehicle to use. Therefore, charging operation of the portable information processing device SP by the occupant is facilitated.

As described above, according to the wireless charging device 10 of the first embodiment, even when the portable information processing device includes the camera module protruding from the body of the portable information processing device, it is possible to stably maintain the mounted portable information processing device and to maintain the positional relationship between the charging coil and the charged coil in a more preferable state. Therefore, high charging efficiency can be maintained.

### Second Embodiment

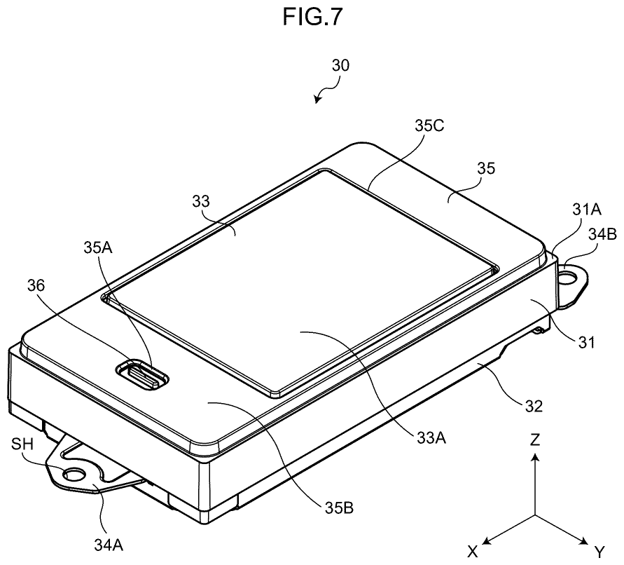

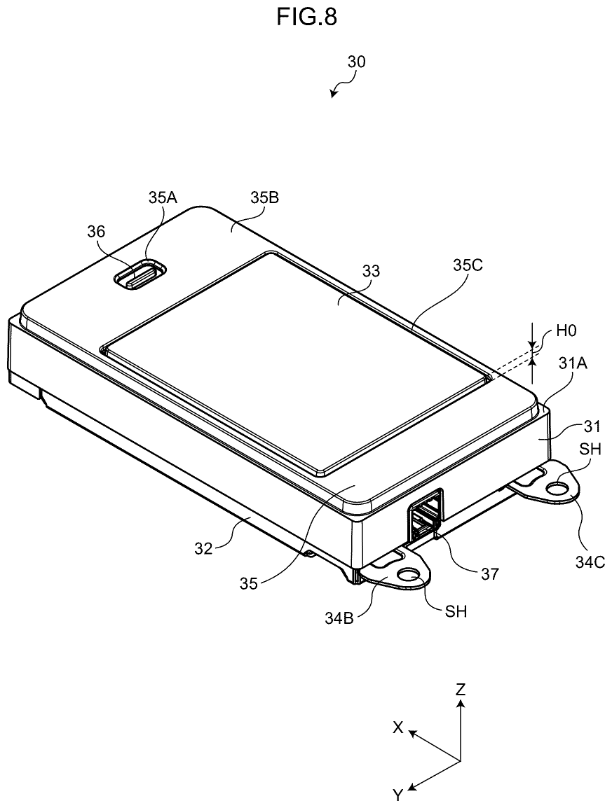

FIG. 7 is a perspective view (1) of an external appearance of a wireless charging device according to a second embodiment illustrating a non-use state. FIG. 8 is a perspective view (2) of an external appearance of the wireless charging device according to the second embodiment illustrating the non-use state.

Similarly to the wireless charging device 10 of the first embodiment, a wireless charging device 30 of the second embodiment is installed in, for example, the tray or the like provided in the center console of the vehicle. As illustrated in FIGS. 7 and 8, the wireless charging device 30 includes an upper case 31, a lower case 32, a pop-up part 33, metal fittings 34A to 34C, and a power connector 37.

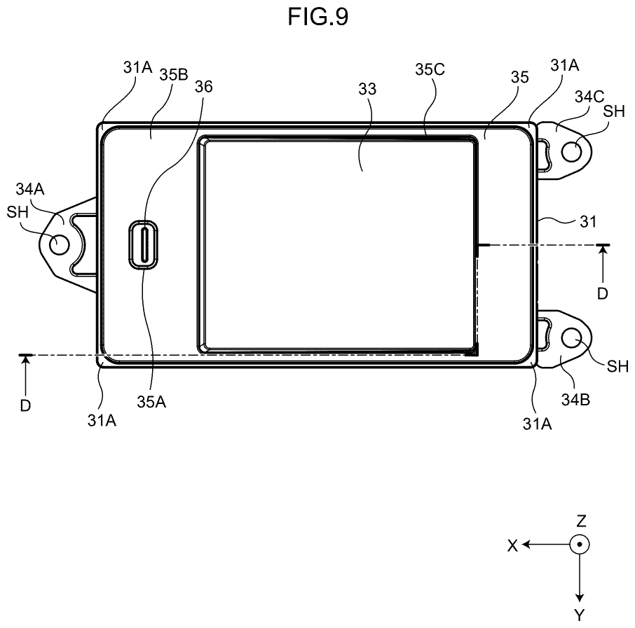

FIG. 9 is a plan view of the wireless charging device according to the second embodiment. As illustrated in FIG. 9, the upper case 31 has a rectangular shape in a plan view (as viewed in the Z-axis positive direction). The upper case 31 includes an abutment surface 31A and an upper plate 35.

The upper plate 35 is provided with an operation opening 35A so as to enable an operation part 36 to protrude therefrom. As will be described later, the upper plate 35 around the operation opening 35A serves as a camera facing surface 35B (namely, the second surface F2). The upper plate 35 is provided with a rectangular opening 35C through which pop-up part 33 is allowed to pop up.

The lower case 32 functions as a casing of the wireless charging device 30 in cooperation with the upper case 31 to store the pop-up part 33. Each of the metal fittings 34A to 34C used for installing in the vehicle is fixed to the lower case 32 by a fastener such as a screw.

As illustrated in FIG. 8, in the non-use state, the pop-up part 33 is housed in the upper case 31 and protrudes from the upper plate 35 by a height H0 (e.g., 0.8 mm).

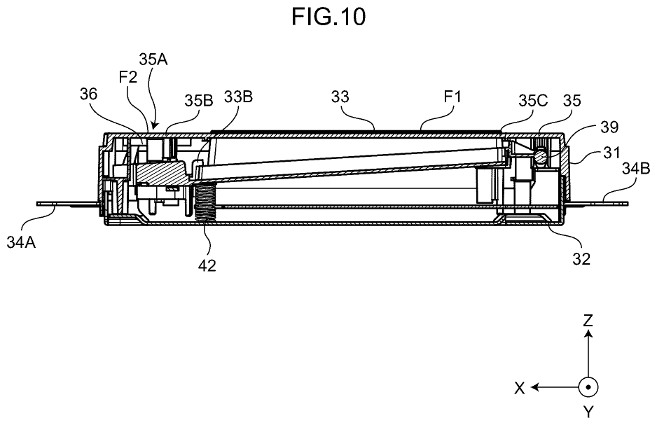

FIG. 10 is a cross-sectional view taken along line D-D of FIG. 9. In FIG. 10, the pop-up part 33 is released from an engagement (not illustrated) when the operation part 36 is slid in the left direction. Then, the pop-up part 33 rotates in a clockwise direction by an urging force of a spring 42 with respect to a rotation shaft 39 rotatably provided in the upper case 31 as a rotation center, and is thereby popped up to protrude from the upper plate 35.

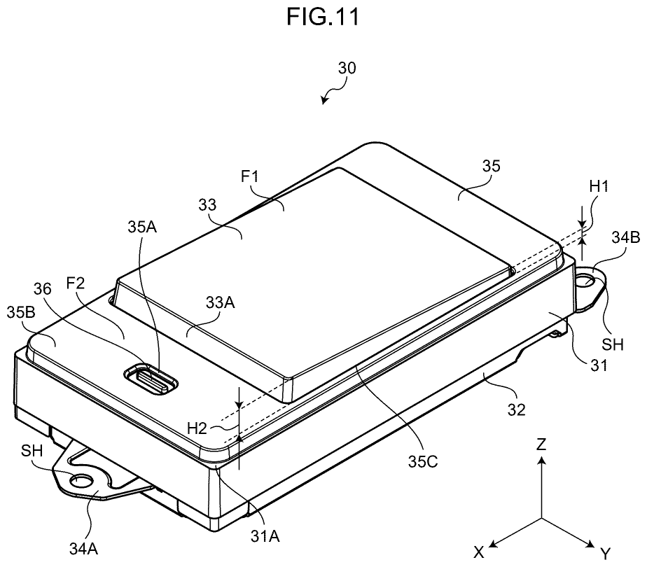

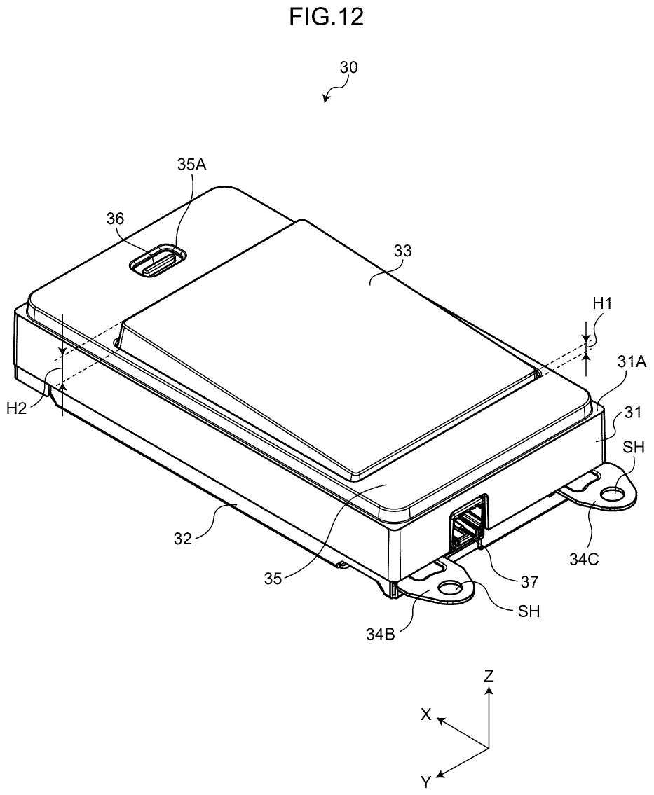

FIG. 11 is a perspective view (1) of an external appearance of the wireless charging device according to the second embodiment illustrating a use state. FIG. 12 is a perspective view (2) of an external appearance of the wireless charging device according to the second embodiment illustrating the use state.

As illustrated in FIGS. 11 and 12, in the use state, the wireless charging device 30 is configured such that the pop-up part 33 is turned to protrude from the upper case 31, and one end surface of the pop-up part 33 appears as a stepped part 33A. In this state, a height from an upper surface of the upper plate 35 to the pop-up part 33 on a side of a rotation end (i.e., the upper right side in FIG. 11 and the lower right side in FIG. 12) is a height H1, and a height of the stepped part 33A is a height H2.

The height H1 is set to a height at which an end of the portable information processing device does not touch the camera facing surface 35B (the second surface F2) that is the upper surface of the upper plate 35, when the portable information processing device assumed as the target to be charged is mounted at a predetermined position on the first surface F1 (the surface in the Z-axis positive direction) that is an upper surface of the pop-up part 33.

In addition, the height H2 of the stepped part 33A is set to be larger than the protruding height of the camera module of the portable information processing device. This configuration allows the camera module protruding from the portable information processing device not to abut on the camera retraction part and not to be scratched when the stepped part 33A protrude by the rotation of the pop-up part 33 function as the camera retraction part by cooperating with the camera facing surface 35B (the second surface F2).

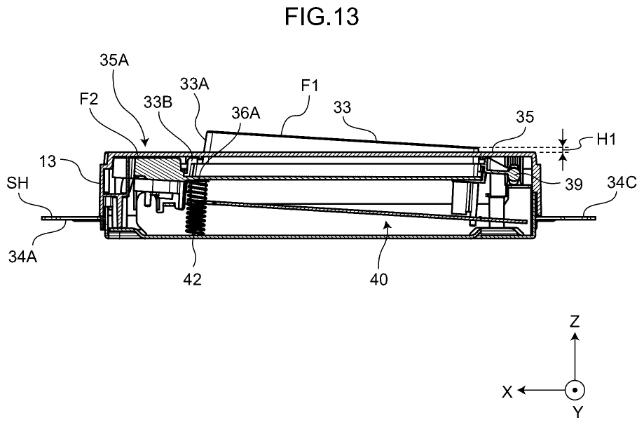

FIG. 13 is a cross-sectional view of a use state corresponding to the cross-section taken along line D-D of FIG. 9. The pop-up part 33 is configured to be rotated in the clockwise direction by a resilient force of the spring 42 about the rotation shaft 39 provided in the upper case 31, until an abutment part 33B abuts on a back surface side of the upper surface of the upper plate 35 so as to protrude from the rectangular opening 35C of the upper case 31.

Prior to description of the use state of the second embodiment, a structure of a charging device body unit 40 in the wireless charging device 30 of the second embodiment will be described. In the wireless charging device 30 of the second embodiment, the charging device body unit 40 including the pop-up part 33 is stored in the upper case 31 and the lower case 32.

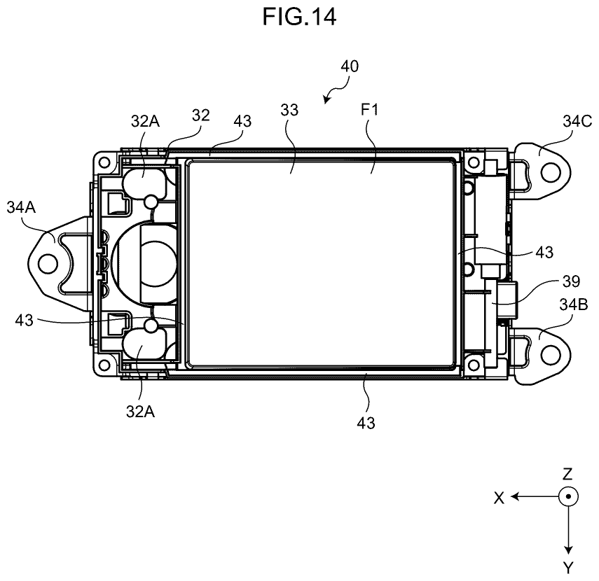

FIG. 14 is a plan view of a charging device body unit 40. FIG. 15 is a perspective view illustrating an external appearance of the charging device body unit 40. The charging device body unit 40 includes the pop-up part 33 and the rotation shaft 39. The pop-up part 33, a pop-up part rotation drive unit 41, and the rotation shaft 39 are supported at the lower case 32.

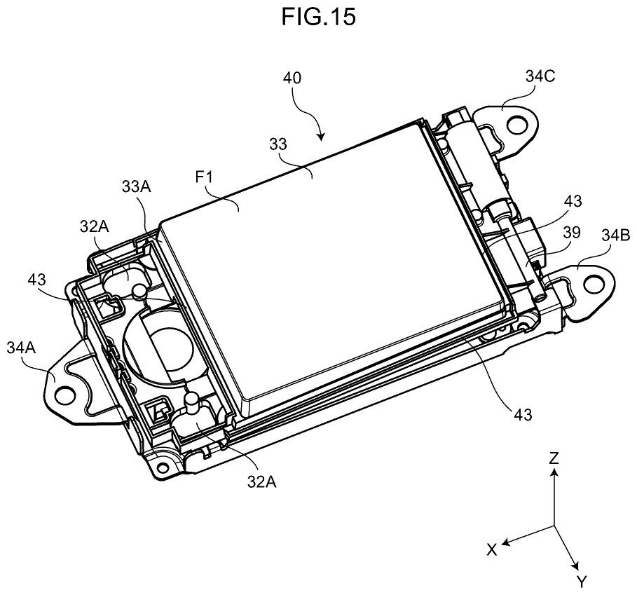

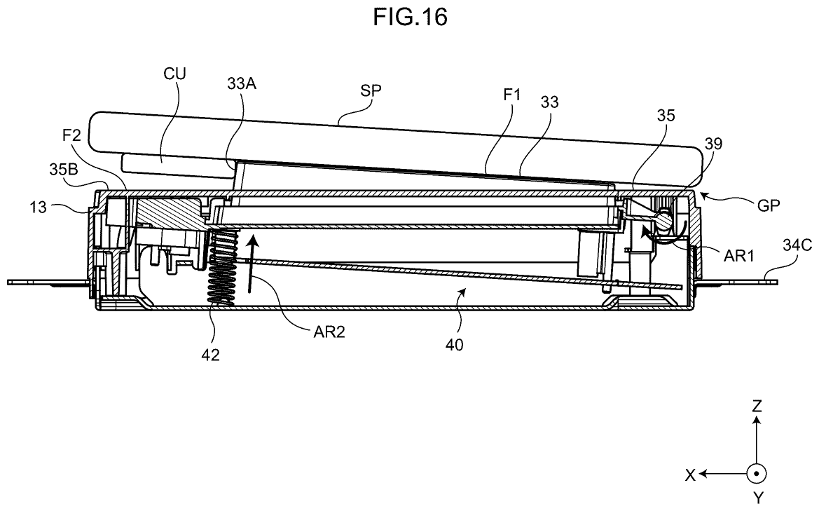

The spring 42 urges the pop-up part 33 upward as indicated by an arrow AR2 in FIG. 16 described later to protrude the pop-up part 33 from the rectangular opening 35C. The spring 42 causes the pop-up part 33 to abut on the upper case 31 to maintain the pop-up state.

Incidentally, the upper case 31 is provided with the rectangular opening 35C, and there is a gap between the rectangular opening 35C and the pop-up part 33. A drainage 43 for preventing liquid such as water entering through the gap from reaching an electric circuit such as a charging board is provided at a position around the pop-up part 33 corresponding to the rectangular opening 35C of the lower case 32.

Then, the liquid collected via the drainage 43 is discharged to the outside of the wireless charging device 30 via an opening 32A provided in a bottom surface of the lower case 32. Therefore, it is possible to prevent occurrence of failure of the wireless charging device 30 due to entry of liquid into the casing.

FIG. 16 is an explanatory diagram of a use state of the wireless charging device according to the second embodiment. In the non-use state of the wireless charging device 30, the pop-up part 33 is stored in the casing formed by the upper case 31 and the lower case 32 as illustrated in FIG. 7. The operation part 36 is slid in a disengagement direction so as to release the engagement which is not illustrated.

As a result, the pop-up part 33 is rotated in a clockwise direction (AR1) by the urging force of the spring 42 which will be described later with the rotation shaft 39 rotatably supported at the upper case 31 as the rotation center, and pops up and projects from the upper plate 35 to be in the use state illustrated in FIG. 11.

In the use state, when the portable information processing device SP is mounted along a main body mounting surface of the pop-up part 33 of the wireless charging device 30, it is preferable to mount the portable information processing device SP such that, as illustrated in FIG. 16, the side surface of the camera module CU of the portable information processing device SP abuts on the stepped part 33A.

This is because, as in the above-described first embodiment, the portable information processing device SP can be stably held, the positional deviation of the portable information processing device during charging is suppressed, and the decrease in charging efficiency between the charging coil and the non-charging coil is suppressed.

In this configuration, the surface of the camera module CU of the portable information processing device SP in the Z-axis negative direction is prevented from abutting on the upper surface of the camera retraction part 13 due to the height of the stepped part 33A. Therefore, the charged coil of the portable information processing device SP is allowed to face the charging coil of the wireless charging device 30 more closely.

Moreover, there is no possibility that the surface of the camera module CU in the Z-axis negative direction abuts on the upper surface of the camera retraction part 13 and is scratched due to a low height of the stepped part 33A, thereby affecting image capture.

Meanwhile, in FIG. 16, as described with FIG. 13, an end of the pop-up part 33 in the X-axis negative direction has a height H1 from the upper plate 35. Therefore, a gap GP is ensured between an end of the portable information processing device SP in the X-axis negative direction and the upper plate 35.

Therefore, the end of the portable information processing device SP in the X-axis negative direction does not touch the upper plate 35, and the body of the information processing device of the portable information processing device SP is allowed to reliably make close contact with the upper surface of the pop-up part 33. As a result, the decrease in charging efficiency can be prevented.

FIG. 17 is an explanatory diagram of the wireless charging device according to the second embodiment illustrating an installed state (non-use state) in the vehicle. In one example, the wireless charging device 30 is installed in the vehicle while being mounted to the tray TR provided in the front console FC.

In this configuration, the wireless charging device 30 is fixed to the back surface side of the tray TR by the metal fittings 34A to 34C such that the abutment surface 31A of the upper case 31 abuts on the back surface side of the tray TR. In this state, an amount of protrusion of the pop-up part 33 from the upper plate 35 is very small (e.g., 0.8 mm), and therefore, the function of the tray TR is not hindered.

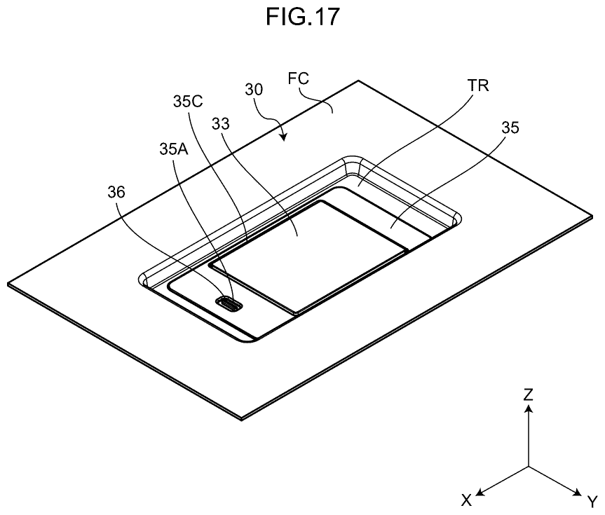

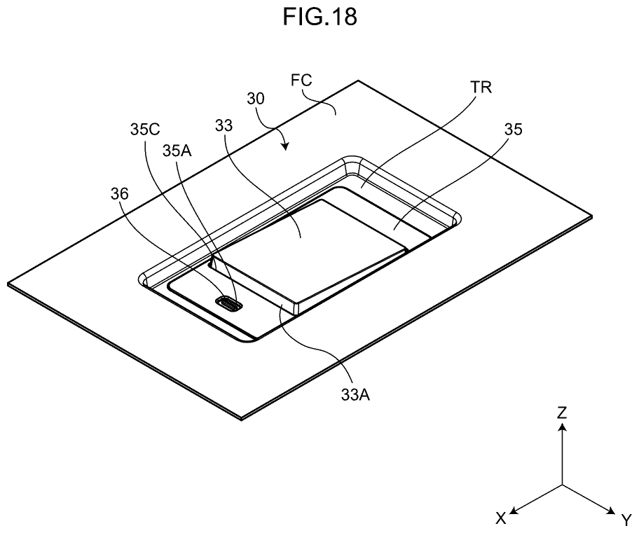

FIG. 18 is an explanatory diagram of the wireless charging device according to the second embodiment illustrating an installed state (use state) in the vehicle. As illustrated in FIG. 18, in the use state, only the camera retraction part 13, the main-body mounting part 14, and the stepped part 33A of the upper case 31 protrude from the upper surface side of the tray TR.

Therefore, in the use state, when the portable information processing device SP is not mounted, the function of the tray TR provided in the front console FC is not restricted more than necessary.

In addition, the front console FC is originally arranged at a position convenient for an occupant (including a driver) of the vehicle to use. Therefore, charging operation of the portable information processing device SP by the occupant is facilitated.

### Third Embodiment

FIG. 19 is a perspective view of an external appearance of a wireless charging device according to a third embodiment illustrating a non-use state.

Similarly to the wireless charging device 10 of the above-described first embodiment and the wireless charging device 30 of the above-described second embodiment, a wireless charging device 50 of the third embodiment is installed in, for example, the tray or the like provided in the center console of the vehicle.

As illustrated in FIG. 19, the wireless charging device 50 includes an upper case 51, a lower case 52, a press-down part 53, and a power connector which is not illustrated. The upper case 51 and the lower case 52 constitute a casing. The upper case 51 includes an abutment surface 51A, an upper plate 55 corresponding to the main body mounting surface, and a press-down part receiving surface 56.

As will be described later, the abutment surface 51A is provided to abut and be fixed on the back surface side of the tray provided in the vehicle when the wireless charging device 50 is installed in the vehicle. The abutment surface 51A is provided at a lower part of the upper case 51 into a U-shape.

An upper surface of the upper plate 55 corresponds to the first surface F1 on which the body of the information processing device is mounted. The upper surface (the first surface F1) of the upper plate 55 of the third embodiment is not inclined but has a horizontal surface shape. The upper surface may be an inclined surface as in the first embodiment or the second embodiment.

As will be described later, the press-down part 53 has an upper surface that serves as a camera facing surface 53C (the second surface F2) facing the camera module of the portable information processing device. The press-down part 53 is configured to maintain a press-down state by a push-latch mechanism, which will be described later, when pressed down in the Z-axis negative direction by the user, and release the latch and return to the original position when pressed down again in the Z-axis negative direction by the user.

Therefore, in the pressed-down state of the press-down part 53, as will be described later, part of a side surface of the upper case 51 serves as a stepped part 51B, and at least part of the upper surface of the press-down part 53 serves as the second surface F2 of the camera retraction part. In addition, a U-shaped abutment surface 53A is provided at a lower part of the press-down part 53. Similarly to the abutment surface 51A, the abutment surface 53A abuts on a back surface side of the tray provided in a vehicle when the wireless charging device 50 is installed in the vehicle.

The lower case 52 functions as a casing of the wireless charging device 50 in cooperation with the upper case 51.

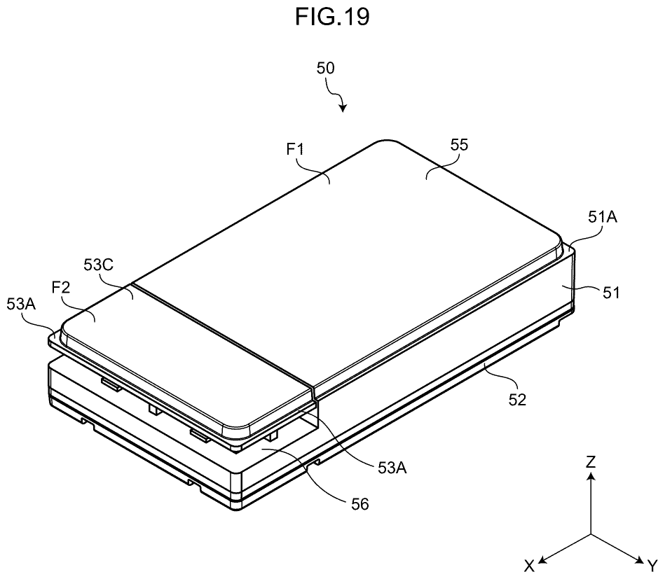

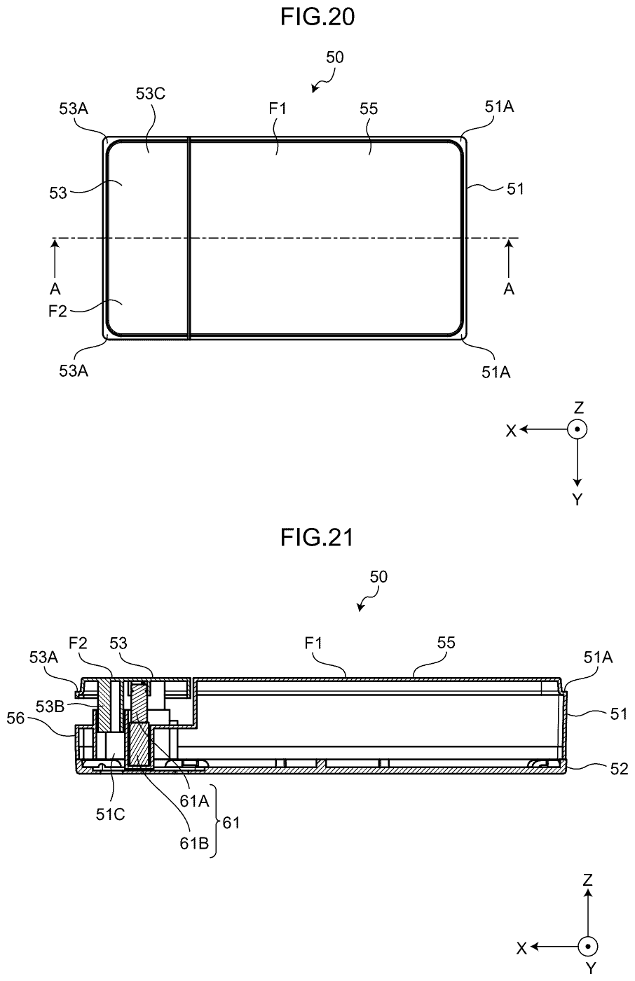

FIG. 20 is a plan view of the wireless charging device according to the third embodiment. As illustrated in FIG. 20, the upper case 51 has a rectangular shape in planar view (as viewed in the Z-axis positive direction).

FIG. 21 is a cross-sectional view of a non-use state taken along line A-A of FIG. 20. The press-down part 53 includes a guide member 53B that extends downward. The press-down part 53 is pressed by the user to bring the wireless charging device 50 into a use state. Therefore, the guide member 53B is slid in a guide groove 51C provided in the upper case 51 and pressed downward, and a lower surface side abuts on the press-down part receiving surface 56.

At this time, a movable latch part 61A of a push-latch mechanism 61 provided in the upper case 51 is configured to be pressed down in accordance with downward movement of the press-down part 53.

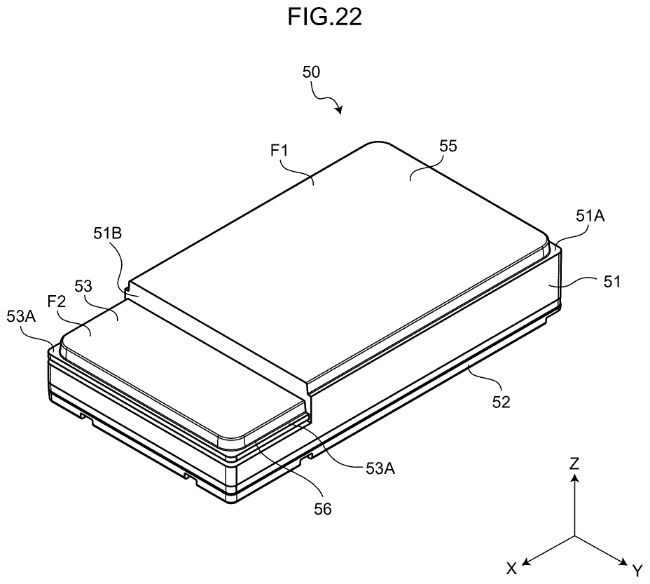

FIG. 22 is a perspective view of an external appearance of the wireless charging device according to the third embodiment illustrating a use state. When the press-down part 53 is pressed down in the Z-axis negative direction in the state of FIG. 19, the guide member 53B is slid in the guide groove 51C and pressed downward, the lower surface side is brought into abutment on the press-down part receiving surface 56, and the press-down part 53 is fixedly latched.

As a result, the wireless charging device 50 is brought into a state as illustrated in FIG. 22, and part of the side surface of the upper case 51 serves as the stepped part 51B.

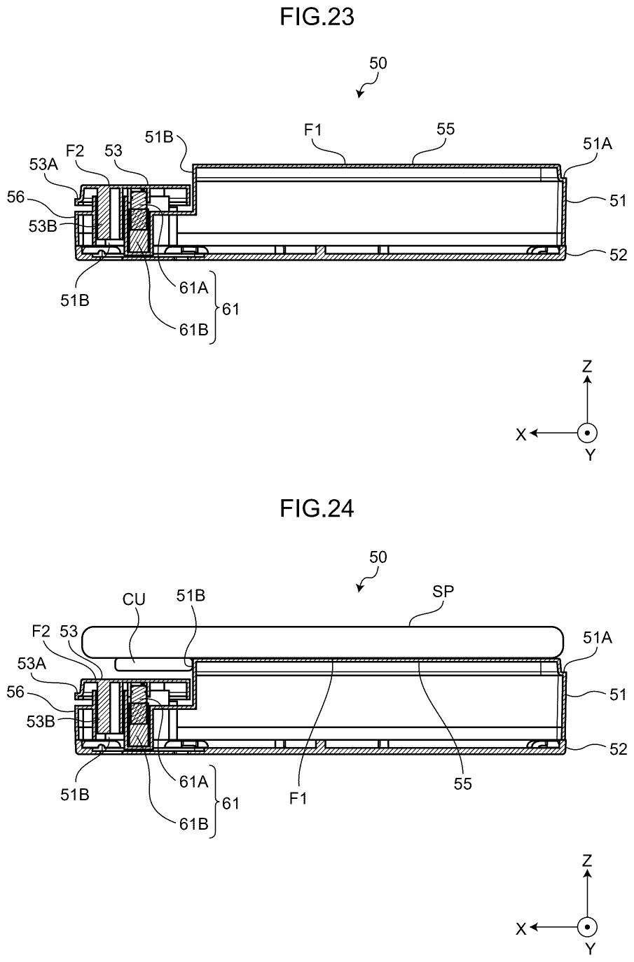

FIG. 23 is a cross-sectional view of a use state taken along line A-A of FIG. 20. When the press-down part 53 is pressed downward by the user, the guide member 53B is slid in the guide groove 51C provided in the upper case 51 and pressed downward, and the lower surface side of the press-down part 53 is brought into abutment on the press-down part receiving surface 56.

In this state, the movable latch part 61A of the push-latch mechanism 61 provided in the upper case 51 is pressed downward and latched by a fixed latch part 61B, and the press-down part 53 is maintained in the press-down state. As a result, the side surface of the upper case 51 facing the press-down part 53 serves as the stepped part 51B.

FIG. 24 is an explanatory diagram of the use state of the wireless charging device according to the third embodiment. When the wireless charging device 50 is used, the upper surface of the press-down part 53 is flush with the upper plate 55 in the non-use state, as illustrated in FIG. 19, and the press-down part 53 is pressed downward.

As a result, the press-down part 53 is kept in the press-down state, the stepped part 51B appears and provides the use state illustrated in FIG. 22.

In this use state, the portable information processing device SP is mounted along the upper surface of the upper plate 55 of the wireless charging device 50. At this time, as illustrated in FIG. 24, it is preferable to mount the portable information processing device SP such that the side surface of the camera module CU of the portable information processing device SP abuts on the stepped part 51B.

This is because, as in the above-described embodiments, the portable information processing device SP can be stably held, the positional deviation of the portable information processing device during charging is suppressed, and a decrease in charging efficiency between the charging coil and the non-charging coil is suppressed.

In this configuration, the surface of the camera module CU of the portable information processing device SP in the Z-axis negative direction is prevented from abutting on the upper surface of the press-down part 53 as the camera retraction part due to the height of the stepped part 51B, namely, due to an amount of pressing of the press-down part 53, and therefore, the charged coil of the portable information processing device SP is allowed to face the charging coil of the wireless charging device 50 more closely.

Moreover, there is no possibility that the surface of the camera module CU in the Z-axis negative direction abuts on the press-down part 53 as the camera retraction part and is scratched due to the height of the stepped part 51B, thereby affecting image capture.

When the wireless charging device 50 of the third embodiment is installed in the vehicle, the wireless charging device 50 is installed in the vehicle while being mounted on the tray TR provided in, for example, the front console FC as in the second embodiment.

The wireless charging device 50 is fixed such that the abutment surface 51A of the upper case 51 and the abutment surface of the press-down part 53 abut on the back surface side of the tray TR. In this state, the press-down part 53 and the upper plate 55 of the wireless charging device 50 are flush with each other. Therefore, a bottom of the tray TR is substantially flat, and the function of the tray TR is not hindered.

In addition, in the wireless charging device 50 of the third embodiment, the press-down part 53 is being pressed downward in the use state, and therefore, the portable information processing device SP is allowed to maintain a horizontal state in the tray TR in a natural state, and therefore, uncomfortable feeling is removed.

In addition, the front console FC is originally arranged at a position convenient for an occupant (including a driver) of the vehicle to use, and therefore, charging operation of the portable information processing device SP by the occupant is facilitated.

As described above, according to each of the embodiments, the camera module is retracted to the camera retraction part while the body of the information processing device is mounted on the mounting part, making it possible to maintain the positional relationship between the charging coil and the charged coil in a predetermined state. Additionally, it is possible to maintain charging efficiency with high level, without the influence of the camera module protruding from the body of the information processing device.

While certain embodiments have been described, these embodiments have been presented by way of example only, and are not intended to limit the scope of the disclosure. Indeed, the novel methods and systems described herein may be embodied in a variety of other forms; furthermore, various omissions, substitutions and changes in the form of the methods and systems described herein may be made without departing from the spirit of the disclosure. The accompanying claims and their equivalents are intended to cover such forms or modifications as would fall within the scope and spirit of the disclosure.

In the above-described embodiments, the wireless charging device is for in-vehicle use, whereas the wireless charging device can be similarly applied to a stationary use.

The effects described in the embodiments are merely examples and not limited, and may have other effects.

### Supplementary Note

The present discloser includes the following aspects.

In a first aspect, a wireless charging device is a wireless charging device wirelessly charging an information processing device via a charging coil, the information processing device including a camera module protruding from a body of the information processing device, the body including a charged coil, the wireless charging device comprising:
a mounting part in which the charging coil is provided, the mounting part including a first surface on which the body of the information processing device is to be mounted; and
a camera retraction part that retracts the camera module, the camera retraction part including a second surface facing the camara part with a gap in a state where the body of the information processing device is mounted at a predetermined position on the first surface.

According to the first aspect, even when the camera module protruding from the body of the portable information processing device is provided, the camera module does not affect a mounting state of the portable information processing device. It is possible to maintain an positional relationship between the charging coil of the wireless charging device and the charged coil of the portable information processing device in a desired state, maintaining charging efficiency with high level.

In a second aspect, the wireless charging device according to the first aspect further comprises a stepped part that has a predetermined height at a position connecting one end of the first surface and one end of the second surface.

According to the second aspect, the stepped part can be configured such that a surface of the camera module intersecting an optical axis direction does not abut on the wireless charging device, and the camera module can be prevented from being scratched.

In a third aspect, the wireless charging device according to the second aspect has a configuration that the predetermined height of the stepped part is larger than an amount of protrusion of the camera module of the information processing device to be charged.

According to the third aspect, it is possible to reliably protect the camera module and not to affect the mounting state of the portable information processing device.

In a fourth aspect, the wireless charging device according to the second aspect has a configuration that the stepped part is allowed to abut on a side surface of the camera module.

According to the fourth aspect, it is possible to maintain a mounting position of the portable information processing device at a predetermined position, and further, maintain the positional relationship between the charging coil of the wireless charging device and the charged coil of the portable information processing device in a desired state, maintaining high charging efficiency.

In a fifth aspect, the wireless charging device according to the fourth aspect has a configuration that, when the second surface is defined as a horizontal surface, the first surface is inclined at a predetermined angle with respect to the horizontal surface and is inclined to have a height decreasing in an extending direction of the body of the information processing device.

According to the fifth aspect, it is possible to maintain abutment of the side surface of the camera module on the stepped part, and more reliably maintain the positional relationship between the charging coil of the wireless charging device and the charged coil of the portable information processing device in a desired state, maintaining high charging efficiency.

In a sixth aspect, the wireless charging device according to the first aspect further includes:
a casing; and
a pop-up part, wherein,
in a non-use state, the pop-up part is stored in the casing,
in a use state, an upper surface of the pop-up part serves as the first surface by being rotated about a rotation shaft as a rotation center and partly protruding from an upper surface of the casing,
the pop-up part includes a side surface, part of which serves as a stepped part having a predetermined height, and
the casing includes an upper surface, part of which serves as the second surface of the camera retraction part.

According to the sixth aspect, in addition to the effect of the wireless charging device of the first aspect, the wireless charging device can have a further flat shape in the non-use state, and for example, even when the wireless charging device is installed in a tray of a front console of a vehicle, the function of the tray is not hindered in the non-use state, even when the camera module protrudes from the body of the portable information processing device, the camera module does not affect a mounting state of the portable information processing device, and it is possible to maintain the positional relationship between the charging coil of the wireless charging device and the charged coil of the portable information processing device in a desired state, maintaining high charging efficiency.

In a seventh aspect, the wireless charging device according to the sixth aspect, further includes:
an engagement part that
   engages with the pop-up part in the non-use state to maintain a state that the pop-up part is stored in the casing, and
   releases the engagement with the pop-up part when shifting to the use state, and
a spring that applies a driving force for rotating the pop-up part by an urging force upon releasing the engagement of the engagement part.

According to the seventh aspect, it is possible to reliably rotate and hold the pop-up part to a predetermined position in the use state of the wireless charging device, and maintain the positional relationship between the charging coil of the wireless charging device and the charged coil of the portable information processing device in a desired state, maintaining the charging efficiency high.

In an eighth aspect, the wireless charging device according to the sixth aspect has a configuration that, in a state where the information processing device is mounted on the first surface, the pop-up part protrudes from the casing by a predetermined amount while being stored in the casing such that an end of the information processing device is separated from an upper surface of the casing.

According to the eighth aspect, in a state where the information processing device assumed as the target to be charged is placed on the first surface, the end of the information processing device does not make contact with the upper surface of the casing, and therefore, it is possible to maintain the positional relationship between the charging coil of the wireless charging device and the charged coil of the portable information processing device in a desired state.

In a ninth aspect, the wireless charging device according to the seventh aspect has a configuration that the pop-up part includes an operation part that is provided in an opening of the second surface so as not to protrude from the casing.

According to the ninth aspect, the operation part does not protrude from an upper surface side of the wireless charging device, and therefore, it is possible to make the upper surface of the wireless charging device substantially flat state in the non-use state of the wireless charging device, maintaining the usability of the installation place of the wireless charging device, enhancing designability.

In a tenth aspect, the wireless charging device according to the first aspect includes:
a casing; and
a press-down part, wherein,
in the non-use state, an upper surface of the press-down part is flush with an upper surface of the casing as the first surface, and,
when the press-down part is pressed downward in a use state,
   part of a side surface of the casing serves as a stepped part having a predetermined height, and
   part of the upper surface of the press-down part serves as the second surface of the camera retraction part.

According to the tenth aspect, in addition to the effect of the wireless charging device according to the first aspect, the wireless charging device can have a further flat shape in the non-use state, maintaining the usability of the installation place of the wireless charging device, enhancing designability, in the non-use state.

What is claimed is:

1. A wireless charging device wirelessly charging an information processing device via a charging coil, the information processing device including a camera module protruding from a body of the information processing device, the body including a charged coil, the wireless charging device comprising:
a mounting part in which the charging coil is provided, the mounting part including a first surface on which the body of the information processing device is to be mounted; and
a camera retraction part that retracts the camera module, the camera retraction part including a second surface facing the camara part with a gap in a state where the body of the information processing device is mounted at a predetermined position on the first surface.

2. The wireless charging device according to claim 1, further comprising a stepped part that has a predetermined height at a position connecting one end of the first surface and one end of the second surface.

3. The wireless charging device according to claim 2, wherein the predetermined height of the stepped part is larger than an amount of protrusion of the camera module of the information processing device to be charged.

4. The wireless charging device according to claim 2, wherein the stepped part is allowed to abut on a side surface of the camera module.

5. The wireless charging device according to claim 4, wherein, when the second surface is defined as a horizontal surface, the first surface is inclined at a predetermined angle with respect to the horizontal surface and is inclined to have a height decreasing in an extending direction of the body of the information processing device.

6. The wireless charging device according to claim 1, further comprising:
a casing; and
a pop-up part, wherein,
in a non-use state, the pop-up part is stored in the casing,
in a use state, an upper surface of the pop-up part serves as the first surface by being rotated about a rotation shaft as a rotation center and partly protruding from an upper surface of the casing,
the pop-up part includes a side surface, part of which serves as a stepped part having a predetermined height, and
the casing includes an upper surface, part of which serves as the second surface of the camera retraction part.

7. The wireless charging device according to claim 6, further comprising:
an engagement part that
engages with the pop-up part in the non-use state to maintain a state that the pop-up part is stored in the casing, and
releases the engagement with the pop-up part when shifting to the use state, and
a spring that applies a driving force for rotating the pop-up part by an urging force upon releasing the engagement of the engagement part.

8. The wireless charging device according to claim 6, wherein, in a state where the information processing device is mounted on the first surface, the pop-up part protrudes from the casing by a predetermined amount while being stored in the casing such that an end of the information processing device is separated from an upper surface of the casing.

9. The wireless charging device according to claim 7, wherein the pop-up part includes an operation part that is provided in an opening of the second surface so as not to protrude from the casing.

10. The wireless charging device according to claim 1, further comprising:
a casing; and
a press-down part, wherein,
in the non-use state, an upper surface of the press-down part is flush with an upper surface of the casing as the first surface, and,
when the press-down part is pressed downward in a use state,
part of a side surface of the casing serves as a stepped part having a predetermined height, and
part of the upper surface of the press-down part serves as the second surface of the camera retraction part.
